(19) United States
(12) Patent Application Publication
(10) Pub. No.: US 2024/0063830 A1
(43) Pub. Date: Feb. 22, 2024

(54) CONFIGURABLE DIPLEXER FOR DUAL BAND SUPPORT

(71) Applicant: Meta Platforms Technologies, LLC, Menlo Park, CA (US)

(72) Inventors: Paul Klies, Woodinville, WA (US); Yuen Hui Chee, Los Gatos, CA (US); Shadi Shawky Tawfik Youssef, Campbell, CA (US); Hongyu Zhou, San Francisco, CA (US)

(73) Assignee: Meta Platforms Technologies, LLC, Menlo Park, CA (US)

(21) Appl. No.: 18/235,427

(22) Filed: Aug. 18, 2023

Related U.S. Application Data
(60) Provisional application No. 63/399,472, filed on Aug. 19, 2022.
(60) Provisional application No. 63/403,601, filed on Sep. 2, 2022.
(60) Provisional application No. 63/416,740, filed on Oct. 17, 2022.

(51) Int. Cl. H04B 1/00; H04B 1/48; H04W 74/00

(52) U.S. Cl. CPC H04B 1/0057; H04B 1/48; H04W 74/002

(57) ABSTRACT

The solution can provide a switch-configurable diplexer architecture for dual-band communication. A first diplexer can have a first band for an interlink connection between an access point and a device and a second band for an intralink connection between the device and a second device. The first band and the pass band can be separated by a first gap. A second diplexer can have a third band for the first interlink and a fourth band for the intralink. The third band and the fourth band can be separated by a second gap. The first band and the third band, as well as the second band and the fourth band, can partially overlap. A processor can identify that the access point has selected, for the interlink connection, a first channel corresponding to the second gap and determine, responsive to the identification, to use the second diplexer for the intralink connection.

### CROSS-REFERENCE TO RELATED APPLICATION

This application claims priority to U.S. Provisional Patent Application No. 63/399,472, titled “Configurable Diplexer for Dual Band Support” and filed on Aug. 19, 2022, as well as to U.S. Provisional Patent Application No. 63/416,740, titled “Super Diplexer for Concurrent Dual Band Operation” and filed on Oct. 17, 2022 and to U.S. Provisional Patent Application No. 63/403,601, titled “Systems and Methods of Diplexer Configuration for Antenna” and filed on Sep. 2, 2022, each one of which is herein incorporated by reference in its entirety and for all purposes.

### FIELD OF DISCLOSURE

The present disclosure is generally related to facilitating wireless communication of a wearable device, including but not limited to switch-based multi-diplexer architecture for dual-band communication.

### BACKGROUND

Multi-band multiplexers, also referred to as diplexers, can be used for facilitating communication over different frequency bands in various radio frequency (RF) systems. Artificial reality (XR) such as a virtual reality (VR), an augmented reality (AR), or a mixed reality (MR) provides immersive experience to a user. In one example, a user wearing a head wearable display (HWD) can turn the user's head, and an image of a virtual object corresponding to a location of the HWD and a gaze direction of the user can be displayed on the HWD to allow the user to feel as if the user is moving within a space of artificial reality (e.g., a VR space, an AR space, or a MR space).

In one implementation, an image of a virtual object is generated by an artificial reality computing device communicatively coupled to the HWD. In one example, the HWD includes various sensors that detect a location and/or orientation of the HWD and transmits the detected location and/or orientation of the HWD to the computing device. The computing device can determine a user's view of the space of the artificial reality according to the detected location and/or orientation of the HWD and generate image data indicating an image of the space of the artificial reality corresponding to the user's view. The computing device can transmit the image data to the HWD, by which the image of the space of the artificial reality corresponding to the user's view can be presented to the user. Diplexers can be used for transmitting and receiving wireless communication between computing devices, HWDs and other communication devices across multiple frequency bands.

### SUMMARY

The present solution provides a switch-configurable, front-end diplexer architecture for real-time dual-band concurrent communication across wireless devices. Systems facilitating wireless communication over radio frequency (RF) bands, including 2.4 GHz, 5 GHz and 6 GHz bands of wireless local area networks (WLANs), such as a Wireless-Fidelity (Wi-Fi), can be used for wireless communication between various network devices. The network devices however can further communicate wirelessly (e.g., via the same or a different WLAN) with other local wireless devices, such as head wearable displays (HWDs). However, as each wireless communication can utilize a different channel within a frequency band, it can be difficult for the system to maintain a desired level of communication integrity or isolation (e.g., to sufficiently eliminate interferences or crosstalk from neighboring signal channels) while maintaining simultaneous wireless communications over different channels. This can be particularly challenging in the instances in which an access point (e.g., a wireless Wi-Fi router) establishes a connection over a channel that can overlap with a frequency gap (or isolation gap) of a diplexer that blocks out a frequency range corresponding to the channel. The present solution overcomes this challenge by providing a switch-based solution that can allow for multiple diplexers with offset frequency gaps to be used to facilitate communication across the entire WLAN spectrum. The present solution also allows for a sufficient frequency gap between the communication channels to provide a desired isolation or low level of crosstalk or interference between the channels.

In one aspect, the present solution relates to a system. The system can include a first diplexer having a first pass band for a first wireless connection between an access point and a first device. The first diplexer can include a second pass band for a second wireless connection between the first device and a second device. The first pass band and the second pass band can be separated by a first gap of a first frequency width. The system can include a second diplexer having a third pass band for the first wireless connection and a fourth pass band for the second wireless connection. The third pass band and the fourth pass band can be separated by a second gap of a second frequency width. The first pass band and the third pass band can partially overlap with each other. The second pass band and the fourth pass band can partially overlap with each other. The system can include at least one processor to identify that the access point has selected, for the first wireless connection between the access point and the first device, a first channel corresponding to (e.g., within) the second frequency width of the second gap. The at least one processor can be configured to determine, responsive to the identification (e.g., detection of the channel and its frequency), to use the second pass band for the second wireless connection between the first device and the second device.

The system can include a switch coupled to the first diplexer and the second diplexer to select/switch, responsive to the determination, between the first diplexer and the second diplexer. The system can include an antenna coupled to the switch. The at least one processor can be configured to detect that the first channel falls within the second frequency width of the second gap. The at least one processor can be configured to determine to use the first pass band of the first diplexer for the first connection, and the second pass band of the first diplexer for the second connection, responsive to the detection. The switch can be configured to select the first diplexer, from the first diplexer and the second diplexer, in response to detecting that the second pass band corresponds the first diplexer.

The first frequency width of the first gap and the second frequency width of the second gap can partially overlap with each other and can have different sizes. The first frequency width of the first gap can partially overlap with the fourth pass band and the second frequency width of the second gap can partially overlap with the first pass band. The first diplexer and the second diplexer can correspond to at least a portion of a frequency range of between 5150 MHz and 7125 MHz. The first frequency width and the second frequency can correspond to at least 200 MHz. The isolation between the first pass band and the second pass band and between the third pass band and the fourth pass band can each be at least 50 decibels (dB).

The at least one processor can be configured to determine to provide a first communication via the first connection between the access point and the first device through the first channel of a first pass band. The at least one processor can determine to provide a second communication via the second connection between the first device and the second device through a second channel of the second pass band. The at least one processor can configure a switch to couple an antenna to the first diplexer. The at least one processor can communicate the first communication through the first pass band of the first diplexer and can communicate the second communication through the second pass band of the first diplexer.

The at least one processor can be configured to identify that the access point has selected, for a third wireless connection between the access point and the first device, a third channel corresponding to the first frequency width of the first gap. The at least one processor can be configured to determine, responsive to the detection for the third wireless connection, to use the fourth pass band for a fourth wireless connection between the first device and a third device.

The at least one processor can be configured to determine to provide a third communication via the third wireless connection between the access point and the first device through the third channel of a third pass band. The at least one processor can be configured to determine to provide a fourth communication via the fourth wireless connection between the first device and the second device through a second channel of the fourth pass band. The at least one processor can be configured to configure a switch to couple an antenna to the second diplexer. The at least one processor can be configured to communicate the first communication through the third pass band of the second diplexer. The at least one processor can be configured to communicate the second communication through the fourth pass band of the second diplexer.

In one aspect, the present solution is directed to a method. The method can include providing a first diplexer having a first pass band for a first wireless connection between an access point and a first device, and a second pass band for a second wireless connection between the first device and a second device. The first pass band and the second pass band can be separated by a first gap of a first frequency width. The method can include providing a second diplexer having a third pass band for the first wireless connection and a fourth pass band for the second wireless connection. The third pass band and the fourth pass band can be separated by a second gap of a second frequency width. The first pass band and the third pass band can partially overlap with each other. The second pass band and the fourth pass band can partially overlap with each other. The method can include at least one processor identifying that the access point has selected, for the first wireless connection between the access point and the first device, a first channel corresponding to the second frequency width of the second gap. The method can include the at least one processor determining, responsive to the identification. to use the second pass band for the second wireless connection between the first device and the second device.

The method can include providing a switch coupled to the first diplexer and the second diplexer to select, responsive to the determination, between the first diplexer and the second diplexer. The method can include providing an antenna coupled to the switch. The method can include the at least one processor detecting that the first channel falls within the second frequency width of the second gap. The method can include determining, by the at least one processor, to use the first pass band of the first diplexer for the first connection and the second pass band of the first diplexer for the second connection responsive to the detection.

The method can include providing a switch configured to select the first diplexer from the first diplexer and the second diplexer in response to detecting that the second pass band corresponds to the first diplexer. The method can include having/configuring the first frequency width of the first gap and the second frequency width of the second gap to be partially overlapping with each other and having different sizes. The first frequency width of the first gap can partially overlap with the fourth pass band and the second frequency width of the second gap can partially overlap with the first pass band.

The method can include the first diplexer and the second diplexer corresponding to at least a portion of a frequency range of between 5150 MHz and 7125 MHz. The method can include the first frequency width and the second frequency corresponding to at least 200 MHz and an isolation between the first pass band and the second pass band and between the third pass band and the fourth pass band of at least 50 dB.

The method can include the at least one processor determining to provide a first communication via the first connection between the access point and the first device through the first channel of a first pass band. The at least one processor can determine to provide a second communication via the second connection between the first device and the second device through a second channel of the second pass band. The method can include the at least one processor configuring a switch to couple an antenna to the first diplexer, communicating the first communication through the first pass band of the first diplexer, and/or communicating the second communication through the second pass band of the first diplexer.

The method can include the at least one processor identifying that the access point has selected, for a third wireless connection between the access point and the first device, a third channel corresponding to the first frequency width of the first gap. The method can include the at least one processor determining, responsive to the detection for the third wireless connection, to use the fourth pass band for a fourth second wireless connection between the first device and a third device. The method can include the at least one processor determining to provide a third communication via the third wireless connection between the access point and the first device through the third channel of a third pass band. The method can include the at least one processor determining to provide a fourth communication via the fourth wireless connection between the first device and the second device through a second channel of the fourth pass band. The method can include the at least one processor configuring a switch to couple an antenna to the second diplexer, communicating the first communication through the third pass band of the second diplexer, and/or communicating the second communication through the fourth pass band of the second diplexer.

In one aspect, the present solution relates to a device. The device can include a first diplexer having a first pass band for a first wireless connection between an access point and a first device and a second pass band for a second wireless connection between the first device and a second device. The first pass band and the second pass band can be separated by a first gap of a first frequency width. The device can include a second diplexer having a third pass band for the first wireless connection and a fourth pass band for the second wireless connection. The third pass band and the fourth pass band can be separated by a second gap of a second frequency width. The first pass band and the third pass band can partially overlap with each other. The second pass band and the fourth pass band can partially overlap with each other. The device can include at least one processor coupled with memory and configured to identify that the access point has selected, for the first wireless connection between the access point and the first device, a first channel corresponding to the second frequency width of the second gap. The device can include the at least one processor configured to determine, responsive to the identification, to use the second pass band for the second wireless connection between the first device and the second device.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including an artificial reality system, according to an example implementation of the present disclosure.

FIG. 2 is a diagram of a head wearable display, according to an example implementation of the present disclosure.

FIG. 3 is a block diagram of a computing environment according to an example implementation of the present disclosure.

FIG. 4 is a block diagram of a system for switch-configurable diplexer architecture for real-time dual-band (concurrent) communication across wireless devices.

FIG. 5 illustrates an example system utilizing frequency bands for interlink and intralink connections.

FIG. 6 illustrates an example system utilizing a diplexer with a gap separating a first pass band and a second pass band.

FIG. 7 illustrates an example system utilizing a switch matrix to select between diplexers with different (isolation) gaps to accommodate wireless communications via the first pass band and the second pass band.

FIG. 8 illustrates an example system switching between four filters to achieve concurrent operation of the 5 GHz and 6 GHz band communications.

FIG. 9 illustrates an example system switching between filters (e.g., five filters) to achieve a dual band concurrent operation of the 5 GHz and 6 GHz band communications.

FIG. 10 illustrates an example system using a bypass and two filters 455 to achieve a dual band concurrent operation of the 5 GHz and 6 GHz band communications.

FIG. 11 illustrates an example system using a super diplexer using additional band pass filters placed in series to provide improved isolation between two different frequency bands.

FIG. 12 illustrates an example system using a super diplexer with discrete band pass filters and diplexer deployed on a PCB or a SiP module.

FIG. 13 illustrates an example system using a super diplexer with discrete band pass filters and diplexer deployed on a semiconductor die.

FIG. 14 illustrates an example system using a super diplexer with band pass filters and embedded front end modules (FEMs) on PCB or a SiP module.

FIG. 15 illustrates an example flow diagram of a method for providing a real-time dual-band concurrent communication across wireless devices using a switch-configurable, front-end diplexer architecture.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

The present solution provides systems and methods for maintaining effective communication integrity and minimizing interference in wireless devices to facilitate real-time dual-band concurrent communication. Wireless devices can communicate across various RF bands, including 2.4 GHz, 5 GHz, and 6 GHz of a wireless local area network (WLANs), such as the Wi-Fi. Likewise, computing devices can communicate with other nearby devices (such as head wearable displays) via the same or different WLANs. In such configurations it can be challenging to preserve communication quality/isolation and eliminate interference from neighboring signal channels (e.g., in the neighboring pass bands) while simultaneous communications are ongoing. This challenge can occur, for example, when access points, such as wireless Wi-Fi routers, establish connections over channels that might overlap with the frequency gaps of particular diplexers used for managing wireless communication.

To overcome such challenges, the proposed solution introduces a switch-configurable, front-end diplexer architecture allowing for seamless wireless communication across the entire WLAN spectrum of the access point (e.g., 2.4 GHz, 5 GHz and/or 6 GHz), while mitigating crosstalk and interference issues. Using switches to select diplexers with differently offset frequency (isolation) gaps (e.g., to accommodate the access point selected communication channel), the present solution can provide the desired communication integrity (e.g., maintaining the communication signal at about 50 dB above the interference or cross talk) while simultaneously allowing usage of the entire WLAN communication band (e.g., by selecting diplexers with suitable pass bands and gaps), and providing a frequency gap (e.g., over 200 MHz) sufficient to maintain the interference level between communication channels below the acceptable threshold (e.g., 50 dBs with respect to the communicated signal). Consequently, the architecture of the present solution accommodates the diverse frequency requirements of local computing devices and other wireless peripherals, enhancing communication reliability and minimizing interference.

Disclosed is related to implementing a RF communication system with a narrow gap between two frequency bands. In one approach, a wireless communication system can be implemented to support a 5G band and 6G band, where a gap between the 5G band and the 6G band can be about 100 MHz, 200 MHz, or more than 200 MHz. In some instances, existing diplexers may not allow such narrow gaps or may not maintain a sufficiently low level of crosstalk at such narrow gaps. Instead, existing diplexers can utilize or rely on at least 200 MHz gap between two frequency bands. The gap of at least 200 MHz can be sufficient to maintain the interference and crosstalk at sufficiently low levels.

In one approach, two diplexers and a switch can be implemented to support a 5G band and a 6G band with a gap between them. The (isolation) gap can be at least 100 MHz, 200 MHz, 250 MHz, 300 MHz or more than 300 MHz. In one aspect, two diplexers may have pass bands that are at least partly offset with respect to each other. For example, a first diplexer may allow communication between 5.17˜5.835 GHz (e.g., first band of the first diplexer) and 6.105˜7.125 GHz (e.g., second band of the first diplexer), whereas a second diplexer may allow communication between 5.17˜5.730 GHz (e.g., first band of the second diplexer) and 5.945˜7.125 GHz (e.g., second band of the second diplexer). When a communication through the 5.730˜5.835 band is desired, then one or more switches coupled with the filters providing the pass bands can be configured to select the first diplexer. Meanwhile, if a communication through the 5.945˜6.105 GHz band is desired, the switch can be configured to select the second diplexer.

In one aspect, the disclosed device can be implemented as a soft access point (AP) that can communicates with an AP and a wireless device (e.g., HWD). For example, the soft AP can communicate with the AP through the 5G band or the 6G band, and simultaneously communicate with the wireless device (e.g., HWD) through the other of the 5G band or the 6G band. Depending on the channel requirement (either 5.730˜5.835 GHz or 5.945˜6.105 GHz can be utilized), the first diplexer or the second diplexer can be selected to support simultaneous communication with the AP and the wireless device. Although disclosed system and methods herein are described to provide dual band communication (e.g., Wi-Fi 5G band and Wi-Fi 6G band) for artificial reality through a wireless LAN protocol (e.g., Wi-Fi), disclosed systems and methods can be implemented to provide dual band communication for any application or any data through any wireless protocol.

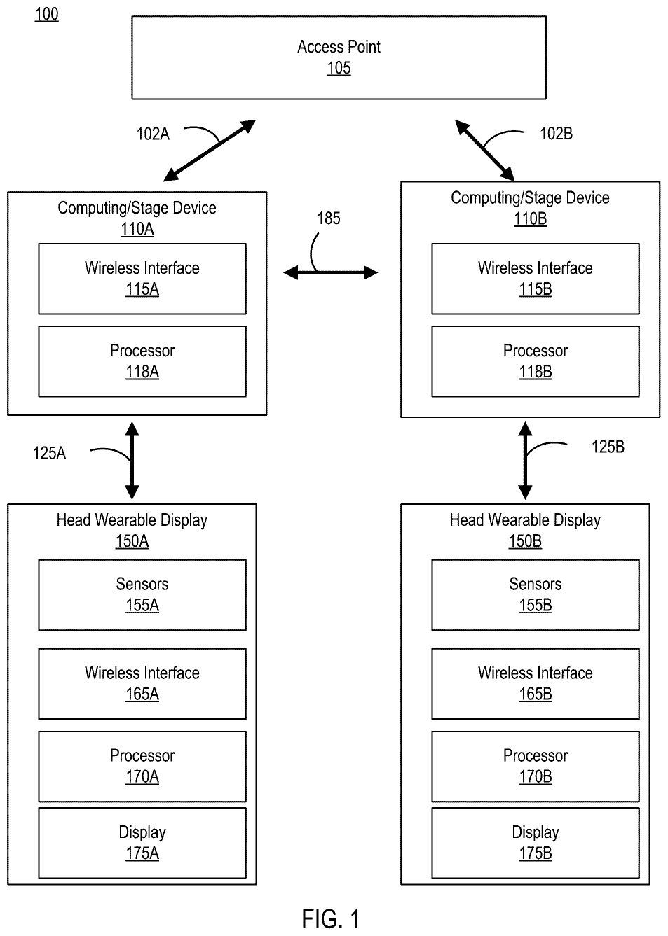

FIG. 1 is a block diagram of an example artificial reality system environment 100. In some embodiments, the artificial reality system environment 100 includes an access point (AP) 105, one or more HWDs 150 (e.g., HWD 150A, 150B), and one or more computing devices 110 (computing devices 110A, 110B; sometimes referred to as stage devices or consoles) providing data for artificial reality to the one or more HWDs 150. The access point 105 may be a router or any network device allowing one or more computing devices 110 and/or one or more HWDs 150 to access a network (e.g., the Internet). The access point 105 may be replaced by any communication device (cell site). A computing device 110 may be a custom device or a mobile device that can retrieve content from the access point 105 and can provide image data of artificial reality to a corresponding HWD 150. Each HWD 150 may present the image of the artificial reality to a user according to the image data. In some embodiments, the artificial reality system environment 100 includes more, fewer, or different components than shown in FIG. 1. In some embodiments, the computing devices 110A, 110B communicate with the access point 105 through wireless links 102A, 102B (e.g., interlinks), respectively. In some embodiments, the computing device 110A communicates with the HWD 150A through a wireless link 125A (e.g., intralink), and the computing device 110B communicates with the HWD 150B through a wireless link 125B (e.g., intralink). In some embodiments, functionality of one or more components of the artificial reality system environment 100 can be distributed among the components in a different manner than is described here. For example, some of the functionality of the computing device 110 may be performed by the HWD 150. For example, some of the functionality of the HWD 150 may be performed by the computing device 110.

In some embodiments, the HWD 150 is an electronic component that can be worn by a user and can present or provide an artificial reality experience to the user. The HWD 150 may be referred to as, include, or be part of a head mounted display (HMD), head mounted device (HMD), head wearable device (HWD), head worn display (HWD), or head worn device (HWD). The HWD 150 may render one or more images, video, audio, or some combination thereof to provide the artificial reality experience to the user. In some embodiments, audio is presented via an external device (e.g., speakers and/or headphones) that receives audio information from the HWD 150, the computing device 110, or both, and presents audio based on the audio information. In some embodiments, the HWD 150 includes sensors 155, a wireless interface 165, a processor 170, and a display 175. These components may operate together to detect a location of the HWD 150 and a gaze direction of the user wearing the HWD 150 and render an image of a view within the artificial reality corresponding to the detected location and/or orientation of the HWD 150. In other embodiments, the HWD 150 includes more, fewer, or different components than shown in FIG. 1.

In some embodiments, the sensors 155 include electronic components or a combination of electronic components and software components that detects a location and an orientation of the HWD 150. Examples of the sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and the rotational movement and determine an orientation and location of the HWD 150. In one aspect, the sensors 155 can detect the translational movement and the rotational movement with respect to a previous orientation and location of the HWD 150 and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the wireless interface 165 includes an electronic component or a combination of an electronic component and a software component that communicates with the computing device 110. In some embodiments, the wireless interface 165 includes or is embodied as a transceiver for transmitting and receiving data through a wireless medium. The wireless interface 165 may communicate with a wireless interface 115 of a corresponding computing device 110 through a wireless link 125 (e.g., intralink). The wireless interface 165 may also communicate with the access point 105 through a wireless link (e.g., interlink). Examples of the wireless link 125 include a near field communication link, Wi-Fi, Bluetooth, or any wireless communication link. Through the wireless link 125, the wireless interface 165 may transmit to the computing device 110 data indicating the determined location and/or orientation of the HWD 150, the determined gaze direction of the user, and/or hand tracking measurement. Moreover, through the wireless link 125, the wireless interface 165 may receive from the computing device 110 image data indicating or corresponding to an image to be rendered.

In some embodiments, the processor 170 includes an electronic component or a combination of an electronic component and a software component that generates one or more images for display, for example, according to a change in view of the space of the artificial reality. In some embodiments, the processor 170 is implemented as one or more graphical processing units (GPUs), one or more central processing unit (CPUs), or a combination of them that can execute instructions to perform various functions described herein. The processor 170 may receive, through the wireless interface 165, image data describing an image of artificial reality to be rendered and render the image through the display 175. In some embodiments, the image data from the computing device 110 may be encoded, and the processor 170 may decode the image data to render the image. In some embodiments, the processor 170 receives, from the computing device 110 through the wireless interface 165, object information indicating virtual objects in the artificial reality space and depth information indicating depth (or distances from the HWD 150) of the virtual objects. In one aspect, according to the image of the artificial reality, object information, depth information from the computing device 110, and/or updated sensor measurements from the sensors 155, the processor 170 may perform shading, reprojection, and/or blending to update the image of the artificial reality to correspond to the updated location and/or orientation of the HWD 150.

In some embodiments, the display 175 is an electronic component that displays an image. The display 175 may, for example, be a liquid crystal display or an organic light emitting diode display. The display 175 may be a transparent display that allows the user to see through. In some embodiments, when the HWD 150 is worn by a user, the display 175 is located proximate (e.g., less than 3 inches) to the user's eyes. In one aspect, the display 175 emits or projects light towards the user's eyes according to image generated by the processor 170. The HWD 150 may include a lens that allows the user to see the display 175 in a close proximity.

In some embodiments, the processor 170 performs compensation to compensate for any distortions or aberrations. In one aspect, the lens introduces optical aberrations such as a chromatic aberration, a pin-cushion distortion, barrel distortion, etc. The processor 170 may determine a compensation (e.g., predistortion) to apply to the image to be rendered to compensate for the distortions caused by the lens, and apply the determined compensation to the image from the processor 170. The processor 170 may provide the predistorted image to the display 175.

In some embodiments, the computing device 110 is an electronic component or a combination of an electronic component and a software component that provides content to be rendered to the HWD 150. The computing device 110 may be embodied as a mobile device (e.g., smart phone, tablet PC, laptop, etc.). The computing device 110 may operate as a soft access point. In one aspect, the computing device 110 includes a wireless interface 115 and a processor 118. These components may operate together to determine a view (e.g., a FOV of the user) of the artificial reality corresponding to the location of the HWD 150 and the gaze direction of the user of the HWD 150, and can generate image data indicating an image of the artificial reality corresponding to the determined view. The computing device 110 may also communicate with the access point 105, and may obtain AR/VR content from the access point 105, for example, through the wireless link 102 (e.g., interlink). The computing device 110 may receive sensor measurement indicating location and the gaze direction of the user of the HWD 150 and provide the image data to the HWD 150 for presentation of the artificial reality, for example, through the wireless link 125 (e.g., intralink). In other embodiments, the computing device 110 includes more, fewer, or different components than shown in FIG. 1.

In some embodiments, the wireless interface 115 is an electronic component or a combination of an electronic component and a software component that communicates with the HWD 150, the access point 105, other computing device 110, or any combination of them. In some embodiments, the wireless interface 115 includes or is embodied as a transceiver for transmitting and receiving data through a wireless medium. The wireless interface 115 may be a counterpart component to the wireless interface 165 to communicate with the HWD 150 through a wireless link 125 (e.g., intralink). The wireless interface 115 may also include a component to communicate with the access point 105 through a wireless link 102 (e.g., interlink). Examples of wireless link 102 include a cellular communication link, a near field communication link, Wi-Fi, Bluetooth, 60 GHz wireless link, or any wireless communication link. The wireless interface 115 may also include a component to communicate with a different computing device 110 through a wireless link 185. Examples of the wireless link 185 include a near field communication link, Wi-Fi, Bluetooth, or any wireless communication link. Through the wireless link 102 (e.g., interlink), the wireless interface 115 may obtain AR/VR content, or other content from the access point 105. Through the wireless link 125 (e.g., intralink), the wireless interface 115 may receive from the HWD 150 data indicating the determined location and/or orientation of the HWD 150, the determined gaze direction of the user, and/or the hand tracking measurement. Moreover, through the wireless link 125 (e.g., intralink), the wireless interface 115 may transmit to the HWD 150 image data describing an image to be rendered. Through the wireless link 185, the wireless interface 115 may receive or transmit information indicating the wireless link 125 (e.g., channel, timing) between the computing device 110 and the HWD 150. According to the information indicating the wireless link 125, computing devices 110 may coordinate or schedule operations to avoid interference or collisions.

The processor 118 can include or correspond to a component that generates content to be rendered according to the location and/or orientation of the HWD 150. In some embodiments, the processor 118 includes or is embodied as one or more central processing units, graphics processing units, image processors, or any processors for generating images of the artificial reality. In some embodiments, the processor 118 may incorporate the gaze direction of the user of the HWD 150 and a user interaction in the artificial reality to generate the content to be rendered. In one aspect, the processor 118 determines a view of the artificial reality according to the location and/or orientation of the HWD 150. For example, the processor 118 maps the location of the HWD 150 in a physical space to a location within an artificial reality space, and determines a view of the artificial reality space along a direction corresponding to the mapped orientation from the mapped location in the artificial reality space. The processor 118 may generate image data describing an image of the determined view of the artificial reality space, and transmit the image data to the HWD 150 through the wireless interface 115. The processor 118 may encode the image data describing the image, and can transmit the encoded data to the HWD 150. In some embodiments, the processor 118 generates and provides the image data to the HWD 150 periodically (e.g., every 11 ms or 16 ms).

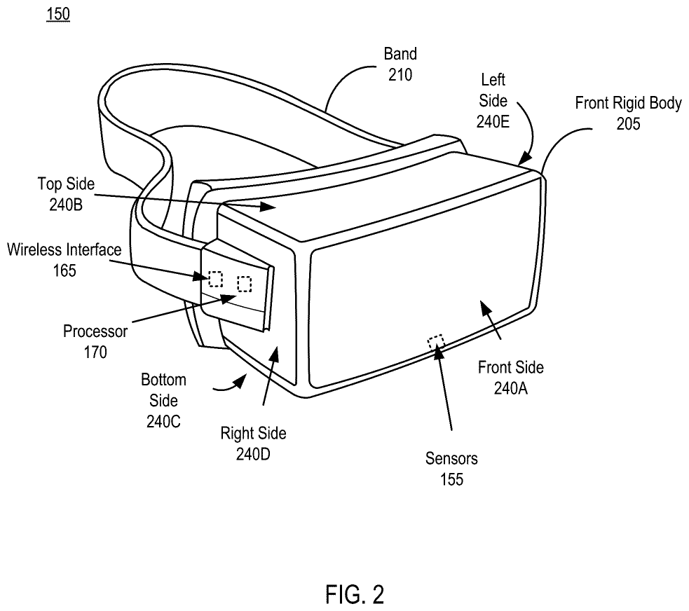

FIG. 2 is a diagram of a HWD 150, in accordance with an example embodiment. In some embodiments, the HWD 150 includes a front rigid body 205 and a band 210. The front rigid body 205 includes the display 175 (not shown in FIG. 2), the lens (not shown in FIG. 2), the sensors 155, the wireless interface 165, and the processor 170. In the embodiment shown by FIG. 2, the wireless interface 165, the processor 170, and the sensors 155 are located within the front rigid body 205, and may not visible to the user. In other embodiments, the HWD 150 has a different configuration than shown in FIG. 2. For example, the wireless interface 165, the processor 170, and/or the sensors 155 may be in different locations than shown in FIG. 2.

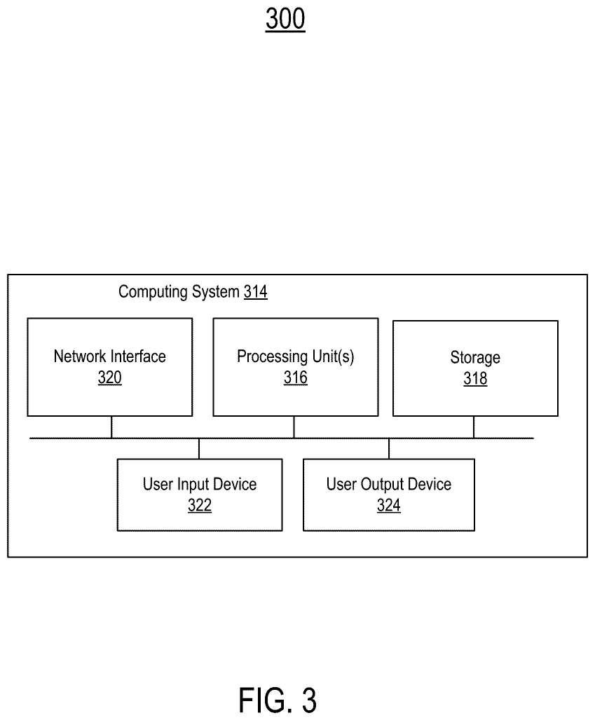

Various operations described herein can be implemented on computer systems. FIG. 3 shows a block diagram of a representative computing system 314 usable to implement the present disclosure. In some embodiments, the access point 105, the computing device 110, the HWD 150 or both of FIG. 1 are implemented by the computing system 314. Computing system 314 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 314 can be implemented to provide VR, AR, MR experience. In some embodiments, the computing system 314 can include conventional computer components such as processors 316, storage device 318, network interface 320, user input device 322, and user output device 324.

Network interface 320 can provide a connection to a wide area network (e.g., the Internet) to which WAN interface of a remote server system is also connected. Network interface 320 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

User input device 322 can include any device (or devices) via which a user can provide signals to computing system 314; computing system 314 can interpret the signals as indicative of particular user requests or information. User input device 322 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 324 can include any device via which computing system 314 can provide information to a user. For example, user output device 324 can include a display to display images generated by or delivered to computing system 314. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 324 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 316 can provide various functionality for computing system 314, including any of the functionality described herein as being performed by a server or client, or other functionality associated with message management services.

It will be appreciated that computing system 314 is illustrative and that variations and modifications are possible. Computer systems used in connection with the present disclosure can have other capabilities not specifically described here. Further, while computing system 314 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

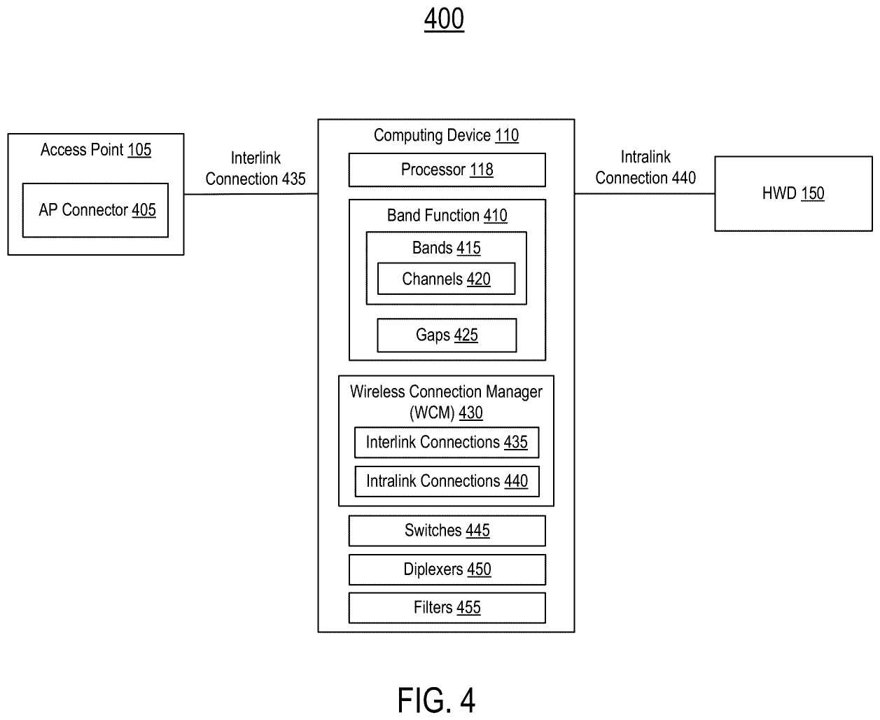

FIG. 4 illustrates a block diagram of an example system 400 for switch-configurable, front-end diplexer architecture for real-time dual-band concurrent communication across wireless devices. System 400 can include an access point 105 exchanging wireless communication via an interlink connection 435 with a computing device 110 that can also exchange wireless communication with a HWD 150. Access point 105 can include one or more access point connectors 405. Computing device 110 can include one or more processors 118, band functions 410, wireless connection managers (WCMs) 430, switches 445, diplexers 450 and/or filters 455. Each band function 410 can include, support or manage one or more bands 415 with one or more channels 420 and gaps 425. Each WCM 430 can include one or more interlink connections 435 and intralink connections 440.

Access point connector 405, also referred to as AP connector 405, can include any combination of hardware and software for establishing, controlling or managing wireless connections with devices on a WLAN network. For instance, AP connector 405 can include functions or programs for establishing and managing wireless connections with computing devices 110 and/or HWDs 150. AP connector 405 can include any functions, computer code or programs selecting or determining channels 420 within bands 415 for wireless communications with network devices (e.g., computing devices 110 and HWDs 150). For example, AP connector 405 can include functionality for selecting a channel in a band 415 for a channel 420 for a particular interlink connection 435 with a computing device 110.

Band 415 can include any designated range of electromagnetic frequencies, such as the 2.4 GHz, 5 GHz, and 6 GHz bands, utilized for wireless local area network (WLAN) connections. Band 415 can be any WLAN frequency band that can include multiple (e.g., tens, hundreds or thousands) of channels 420 within a specified frequency range, allowing for interlink connections 435 with access points 105 and intralink connections 440 with accessory devices like head wearable displays (HWDs 150). Bands 415 can cover any frequency range, such as 2.4 GHz, 5 GHz, and 6 GHz frequency bands 415 serving as expansive communication ranges within which channels 420 can be allocated for specific communication purposes (e.g., particular wireless connections for transmitting or receiving data).

Channels 420 can include any subset of a band 415, such as a frequency range within a WLAN frequency band 415 allocated for transmitting and receiving wireless signals of a particular connection or device. Channels 420 can be referred to as sub-channels of dedicated frequency ranges within the band 415 for facilitating communication between devices and access points with minimized interference. Channel 420 can include specific segments of the electromagnetic spectrum within a designated frequency band 415. Channels 420 can serve as virtual (e.g., frequency ranged) pathways for transmitting and receiving signals and minimizing interference between different communication streams. In different WLANs having bands 415, such as 2.4 GHz, 5 GHz and 6 GHz frequency bands, channels 420 can be used for both interlink connections 435 and intralink connections 440. In intralink connections 440, devices within the same WLAN band, like smartphones and laptops sharing data on a 5 GHz channel, can communicate via dedicated channels 420 without signal collisions. In interlink connections 435, devices can connect to access points 105 through specific channels 420; for instance, a 2.4 GHz or 5 GHz channel connecting smartphones to a Wi-Fi router. Whether facilitating device-to-device interaction or linking devices with access points, channels 420 allow for effective wireless communication by segregating and coordinating signals within WLAN frequency bands 415, allowing filters 455 to maintain the crosstalk and interferences below acceptable or desirable threshold (e.g., 50 dB with respect to the transmitted signal).

Gap 425 can include any unused, unallocated, or blocked range of electromagnetic frequencies designed/configured to prevent interferences or crosstalk between different communication channels 420 or bands 415. Gap 425 can include a range of about 200 or more MHz separating one band 415 from another band 415, such as a 5 GHz band from a 6 GHz band. For example, gap 425 can include an unallocated range of frequencies of a particular frequency width, such as at least 100 Mhz, 150 MHz, 200 MHz, 250 MHz, 300 MHz, 400 MHz, or 500 MHz. Gap 425 can be created to prevent interference between adjacent channels 420 or bands 415 or components utilizing the diplexer. For instance, in the context of a wireless communication system operating in the 5 GHz frequency band, a gap could be introduced to ensure that the signals transmitted through different channels 420 remain distinct and not overlap, or overlap below an acceptable threshold, such as a threshold of 50 dB between the signal and the interference signal, thereby (e.g., providing communication isolation by) minimizing cross-talk and maintaining communication integrity.

Band function 410 can include any combination of hardware and software for establishing, controlling or managing usage of bands 415 and channels 420 for communications of the computing device 110. Band function 410 can include, for example, computer code or functions for selecting bands 415 and/or channels 420 within bands 415. Band function 410 can establish, terminate, manage and/or control connections via channels 420 within particular bands 415 for transmitting or receiving data or communication to and from the computing device 110. Band function 410 can include functionality to select channels 420 for intralink connections 440. Band function 410 can select a first channel 420 in a first band 415 for an intralink connection 440 responsive to a channel 420 selected or used by AP connector 405 to establish an interlink connection 435. For example, in response to AP connector 405 establishing interlink connection 435 via a channel 420 of a 5 GHz band 415, band function 410 can establish an interlink connection 440 via a channel 420 of a 6 GHz band 415.

Band function 410 can include the functionality for selecting diplexers 450 for particular bands 415 and/or channels 420. For example, band function 410 can include the functionality for directing or controlling switches 445 to select or utilize particular diplexers 450 based on the alignment of the channel 420 for interlink connection 435 selected by an AP connector 405 of AP 105 and gaps 425 of the diplexers. For example, band function 410 can select for usage and communication a particular diplexer 450 whose gap 425 does not coincide with, or does not block, a channel 420 of an interlink connection 435 selected by the AP connector 405. For example, band function 410 can unselect/disable/bypass or determine not to utilize a particular diplexer 450 whose gap 425 coincides with or blocks the channel 420 of the interlink connection 435. For example, band function 410 can select a particular channel 420 provided by a particular diplexer 450 for an intralink connection 440 in response to the AP connector 405 selecting for an interlink connection 435 another channel 420 that coincides with a gap 425 of a different diplexer 450. For example, if a first diplexer 450 has a gap 425 that coincides with a channel 420 selected by an AP connector 405 of an AP 105 for interlink connection 435, then the band function 410 can select/use, via a switch 445, another diplexer 450 that provides that channel 420 (e.g., does not have a gap 425 coinciding with the selected interlink channel 420), so as to allow another channel 420 for intralink connection 440 to be selected within another available band 415 of that another diplexer 450.

Wireless connection manager (WCM) 430 can include any combination of hardware and software for managing wireless connections by the computing device 110. WCM 430 can include one or more computer code or functions for establishing, terminating, managing or controlling wireless connections. WCM 430 can establish, manage, use or control interlink connections 435, such as interlink connections 435 via channels 420 selected by the AP connector 405. WCM 430 can establish, manage, use or control intralink connections 440 via channels 420 made available by a diplexer 450 selected by the band function 410.

Switches 445 can include any electronic device or system that provides or enables a selective connection or disconnection of circuits or components, such as diplexers 450. Switches 445 can include any switching mechanisms, devices or circuits for selecting between different diplexers 450 for wireless communication. For example, switch 445 can include an electronic switch, such as CMOS (Complementary Metal-Oxide-Semiconductor) switch, a bipolar junction transistor switch, an RF relay, a PIN diode switch or a micro-electro-mechanical system (MEMS) switch. Switch 445 can include a software-defined or controlled switch, such as a combination of hardware and software that enables or controls switching through digital signal processing.

Switches 445 can be used to select/switch between different diplexers 450 in response to a band function 410 selecting or determining particular diplexers 450 to select and use for a particular communication, transmission or connection. Switch 445 can enable the routing of signals from specific channels to the appropriate diplexer within a given frequency band. Switch 445, often referred to as band selection switch, can dynamically connect a particular diplexer to the signal path based on the selected channel and frequency band, ensuring optimized signal filtering and separation. For instance, in a dual-band Wi-Fi system operating in both the 2.4 GHz and 5 GHz bands 415 (or any other, such as 6 GHz band 415) a switch 445 can be used to select particular diplexers 450 to allow for routing of signals to and from different channels 420. In doing so, switches 445 can allow the suitable diplexers 450 to be selected to allow for effective management of the separation of frequencies and minimizing interference between channels 420. Similarly, in a wireless communication setup involving multiple frequency bands 415 (e.g., 2.4 GHz, 5 GHz, and 6 GHz) switches 445 can be employed to channel signals to corresponding diplexers 450 for communication to preserve signal integrity and minimize crosstalk. Switches 445 can include a switch matrix that can include a complex arrangement of interconnected switches 445 allowing for dynamic routing of signals between multiple input and output ports (e.g., across multiple diplexers 455), based on input signals, thereby providing versatile control over signal pathways in various diplexer 450 configurations.

Diplexers 450 can include any combination of hardware and software, such as a passive electronic device, to separate or combine signals or communications from two different frequency bands 415 within a communication system. Diplexer 450 can include a device having or using filters 455 to create gaps 425 of a particular width (e.g., 200 MHz) to separate two or more bands 415. For example, a diplexer 450 can include two band-pass filters 455 that include a gap of blocked frequency range (e.g., gap 425) of about 200 MHz. Diplexer 450 can include signal processing circuitry to select or provide for communications a particular range of frequencies or bands 415 separated by one or more gaps 425. Diplexer 450 can include a system, or a device characterized by frequency range of bands 415 and/or gaps 425. Diplexer 450 can include or be coupled with filters 455 and switches 445 (e.g., switch matrices) for routing signals to and from diplexers 450.

Diplexer 450 can be configured to be selected using switches 445 (e.g., switch matrix) to accommodate distinct communication needs or arrangement of the solution, allowing for selection of one out of any number of diplexers 450 for a particular device connection. For example, diplexer 450 can facilitate an interlink connection 435 in a first band 415 by routing signals from a first channel, enabling communication between devices and access points. Simultaneously, the diplexer can establish an intralink connection in a second band, guiding signals from a second channel to facilitate seamless communication among local devices. The use of switches 445 allows dynamic selection between these two configurations, enabling efficient wireless communication tailored to both interlink and intralink scenarios across multiple frequency bands.

Filter 455 can include any electronic component that selectively permits passing through of signals in a particular frequency range, while blocking or attenuating signals in other frequency ranges. Filter 455 can include any combination of hardware and software for shaping the signal's frequency content according to specific requirements, such as allowing signals in a certain frequency range to be transmitted without attenuation, while attenuating or eliminating signals in other frequency ranges. Filter 455 can include a low pass filter permitting frequencies below a certain cutoff while attenuating frequencies above the cutoff. Filter 455 can include a high-pass filter allowing frequencies above a certain cutoff to pass through, while suppressing or eliminating frequencies below the cutoff. Filter 455 can include a band pass filters that can allow a specific range of frequencies to pass, while attenuating or eliminating both frequencies above the higher cutoff and below the lower cutoff, thereby acting as a combination of a high pass and low pass filter. Filters 455 can be cascaded to achieve more complex responses, such as a combination of a high-pass and a low-pass filter to create a band-stop filter that blocks a specific frequency range.

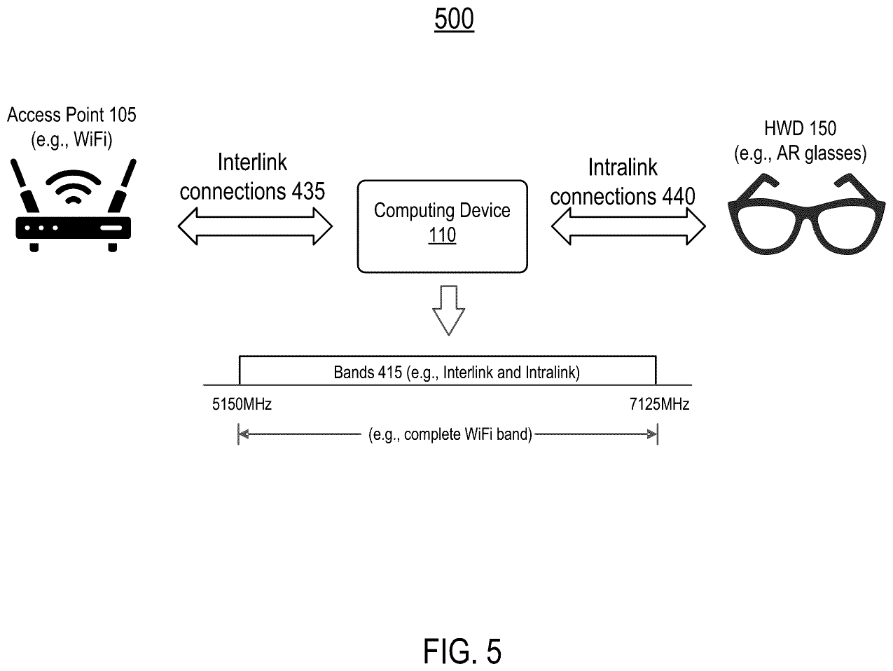

FIG. 5 illustrates an example system 500 utilizing bands 415 for multiple connections/links (e.g., for interlink connection 435 and intralink connection 440). Example system 500 can include a computing device disposed between an access point 105 (e.g., Wi-Fi device) and an HWD 150 (e.g., AR glasses). AP 105 and computing device 110 can communicate with each other via one or more interlink connections 435, while the computing device 110 and the HWD 150 can communicate via one or more intralink connections 440. To implement the interlink connections 435 and intralink connections 440 the computing device 110 can utilize bands 415 corresponding to the intralink and interlink channels 420 in the 5 GHz and 6 GHz band range. Bands 415 can include, for example, the frequency range between 5150 MHz and 7125 MHz, which can correspond to the radio signals of 5 GHz and 6 GHz bands 415. Computing device 110 can utilize any channels 420 within bands 415 (e.g., 5150 MHz and 7125 MHz) for the interlink connections 435 and intralink connections 440.

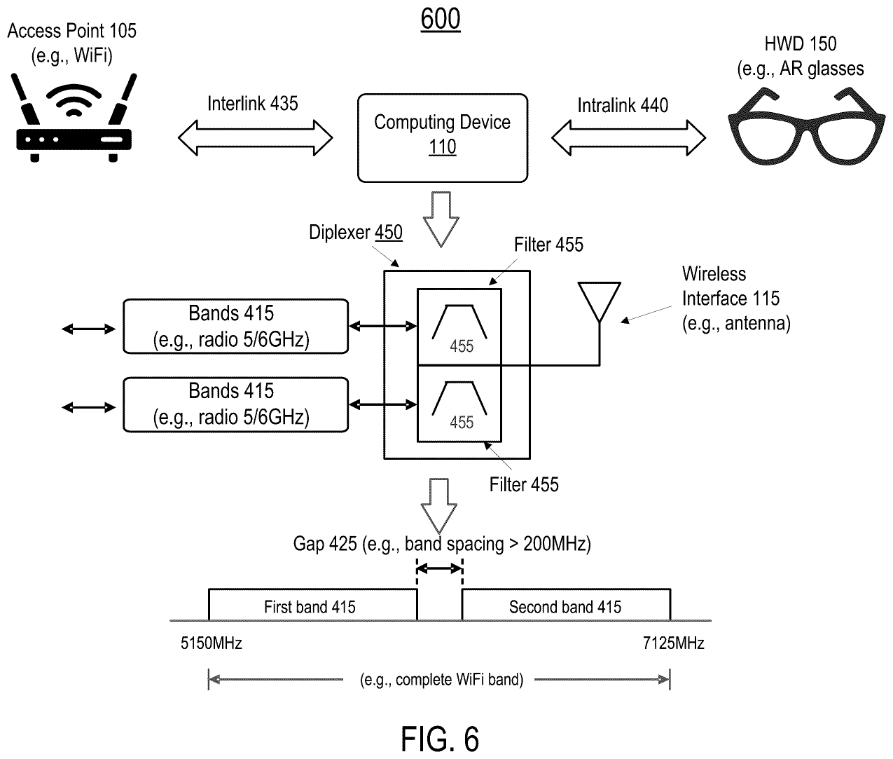

FIG. 6 illustrates an example system 600 utilizing a diplexer 450 with a gap 425 to separate a first band 415 and a second band 415. Example system 600 can include the computing device 110 communicating with AP 105 via one or more interlink connections 435, while also communicating with the HWD 150 via one or more intralink connections 440. Bands 415 can include or support radio 5 GHz and 6 GHz signals that can be filtered by filters 455 of the diplexer 450 having a gap 425 of a band spacing of equal to or greater than 200 MHz. The first band 415 can begin at 5150 MHz and provide frequency coverage until (e.g., ending at) the gap 425. The second band 415 can begin at the end of the gap 425 and end at 7125 MHz. Depending on the design, diplexer 450 can have first band 415 and the second band 415 covering any frequency ranges between the 5150 MHz and 7125 MHz with a gap 425 of at least 200 MHz somewhere within this frequency range.

Diplexer 450 of the system 600 can include two filters 455, each of which can include a band pass filter 455 for each of the two bands 415. A first filter 455 can include a band pass filter for allowing signals within the first band 415 (e.g., 5170 to 5835 MHz, or 5150 to 5835 MHz) to pass through, while a second filter 455 can include a band pass filter 455 for allowing signals within the second band 415 (e.g., 6105 to 7125 MHz, or 5945 to 7125 MHz) to pass through, without attenuation or filtering. Because the two band pass filter 455 can be configured to allow transmission of signals within their respective band ranges, they can attenuate, block or stop transmission of signals in the gap 425 that can correspond to at least 200 MHz (e.g., 5730 MHz to 5945 MHz, or 5835 MHz to 6105 MHz).

Coupled to the output of the diplexer 450 (e.g., the two band pass filters 455) can be a wireless interface 115 with an antenna. The wireless interface 115 (e.g., the antenna and its corresponding signal processing circuit chain) can be shared by both filters 455 and their communications in the respective channels 420 within the first band 415 and the second band 415. As interlink connections 435 and intralink connections 440 can share their transmissions via the same wireless interface 115, the signal integrity can be provided by the diplexer 450, providing the sufficient gap 425 with its band spacing of at least 200 MHz.

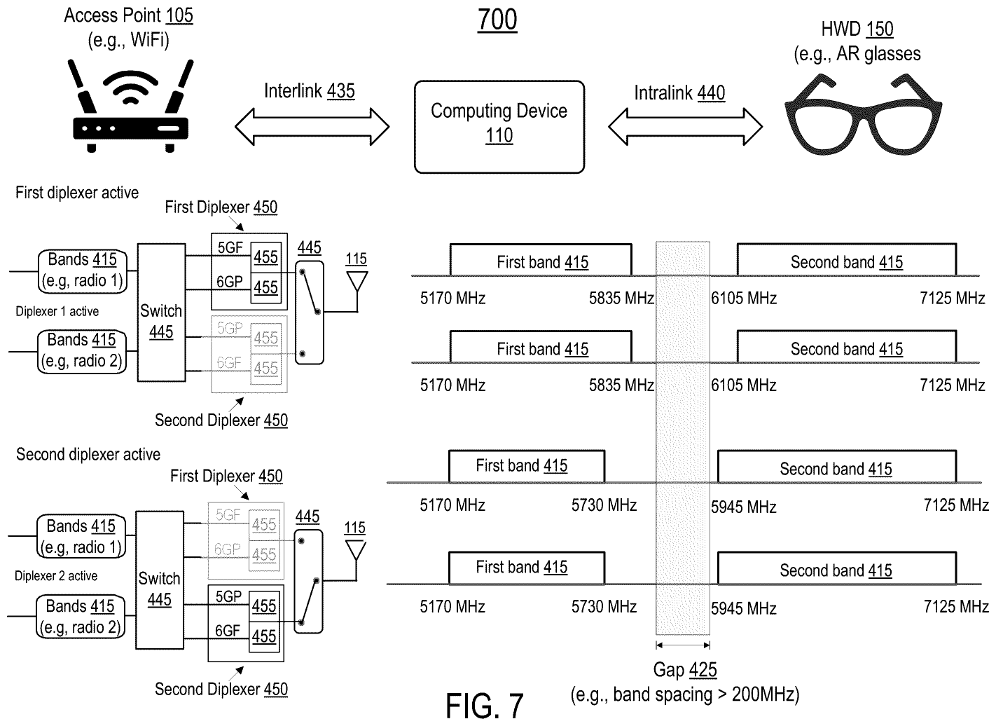

FIG. 7 illustrates an example system 700 utilizing a switch (e.g., a switch matrix) to select between diplexers 450 with different gaps 425 to accommodate wireless communications via the first band 415 and second band 415. As with example systems 400, 500 and 600, example system 700 can include the computing device 110 communicating with AP 105 via one or more interlink connections 435, while also communicating with the HWD 150 (or other type of device) via one or more intralink connections 440. Diplexer 450 of example system 700 can include a first band 415 providing one of the interlink or intralink connections 435 or 440, separate from a second band 415 providing the remaining one of the interlink or intralink connections 435 or 440.

Example system 700 can include an arrangement in which a switch 445 (e.g., switch matrix) selects/switches between two diplexers 450 (e.g., first diplexer 450 and a second diplexer 450). In one example, a first diplexer is active. Specifically, signals in bands 415 of radio 1 and radio 2 (e.g., two different signals or communications) are coming into the switch 445. First diplexer 450 can select a 5 GHz full range band 415 (e.g., 5GF) and a 6 GHz partial range band 415 (e.g., 6GP), which can be provided or filtered by two filters 455 of the first diplexer 450. Second diplexer 450 can select a 5 GHz partial range (e.g., 5GP) and a 6 GHz full range (e.g., 6GF), which can be provided or filtered by two filters 455 of the second diplexer 450. For example, the 5GF band 415 can correspond to the first band 415 of between 5170 MHz and 5835 MHz, whereas 5GP band 415 can correspond to the first band 415 of between 5170 MHz and 5730 MHz. For example, the 6GF band can correspond to the second band 415 of between 5945 MHz and 7125 MHz, whereas the 6GP band can correspond to the second band 415 of between 6105 MHz and 7125 MHz.

Switches 445 can include circuitry before and after the first and second diplexers 450 to allow the outputs of the diplexers 450 to be coupled to the wireless interface 115 (e.g., antenna). For example, a switch matrix 445 can be coupled to the input and/or output of the first and second diplexers 450. Therefore, in the first example in which the first diplexer is active, the switches 445 can couple 5GF and 6GP bands 415 to the antenna 115. For example, in the second example in which the second diplexer is active, the switches 445 can couple 5GP and 6GF bands 415 to the antenna 115. Switches 445 can select particular diplexers 450 based on the commands or instructions processed by the processor 118, processor 170 or processor 316 (e.g., in FIG. 4 or other figures). Such one or more processors can use or execute the band function 410 to determine which diplexer 450 to select and use and for which communication or connection (e.g., interlink connection 435 and/or intralink connection 440).

Also illustrated in FIG. 7, gap 425 between the first band 415 corresponding to 5GF and the second band 415 corresponding to 6GP (e.g., top two band 415 examples) can correspond to a frequency range of between 5835 MHz and 6105 MHz. Likewise, the gap 425 between the first band 415 corresponding to the 5GP and the second gap 425 corresponding to the 6GF can correspond to a frequency range of between 5730 MHz and 5945 MHz. Therefore, depending on the diplexers 450 selected, gaps 425 can be different and cover different channels 420 in the bands 415. As a result, depending on the channel 420 that the AP 105 selects, example system 700 can determine the appropriate diplexer 450 to use, by selecting a diplexer 450 whose gap 425 does not conflict with the selected channel 420. In doing so, the selected diplexer 450 will permit communications within the given channel 420 selected by the AP 105 for interlink connection 435, while also allowing for at least a 200 MHz gap 425 separation from the channel 420 for the intralink connection 440.

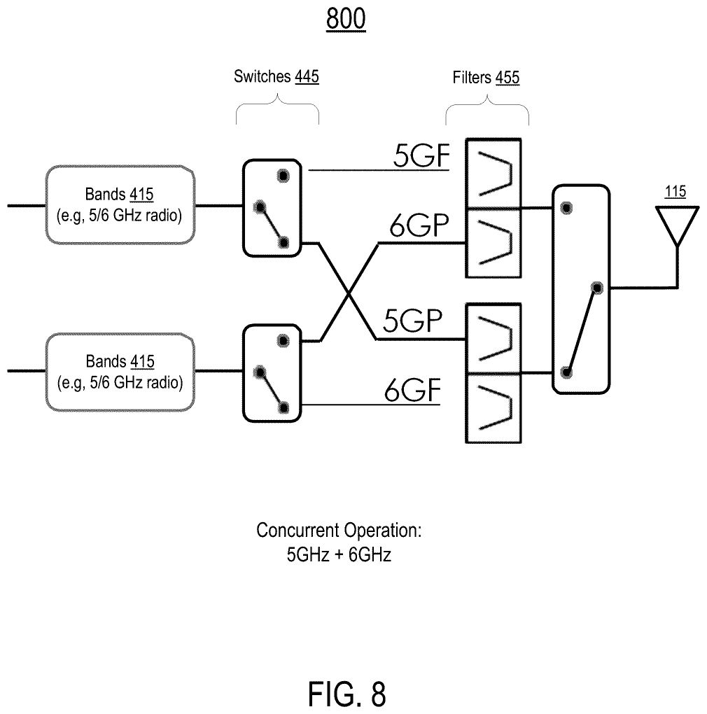

FIG. 8 illustrates an example system 800 switching between four filters 455 to achieve concurrent operation of the 5 GHz and 6 GHz band communications. Example system 800 can refer to an example circuit or a device for selecting between two different diplexers 450. The top two filters 455 can correspond to a first diplexer 450 and can provide a 5 GHz full band 415 (e.g., 5GF) and a 6 GHz partial band 415 (e.g., 6GP). Likewise, the bottom two filters 455 can correspond to a second diplexer 450 and provide a 5 GHz partial band 415 (e.g., 5GP) and 6 GHz full band 415 (e.g., 6GF). Switches 445 (e.g., switch matrix) can allow signals from bands 415 (e.g., 5 GHz and/or 6 GHz data) to be routed via either the two top filters of the first diplexer 450 (e.g., 5GF or 6GP) or two bottom filters 455 of the second diplexer 450 (e.g., 5GP or 6GF). In doing so, the system 800 can achieve or allow for concurrent operation via any combination of two diplexers 450.

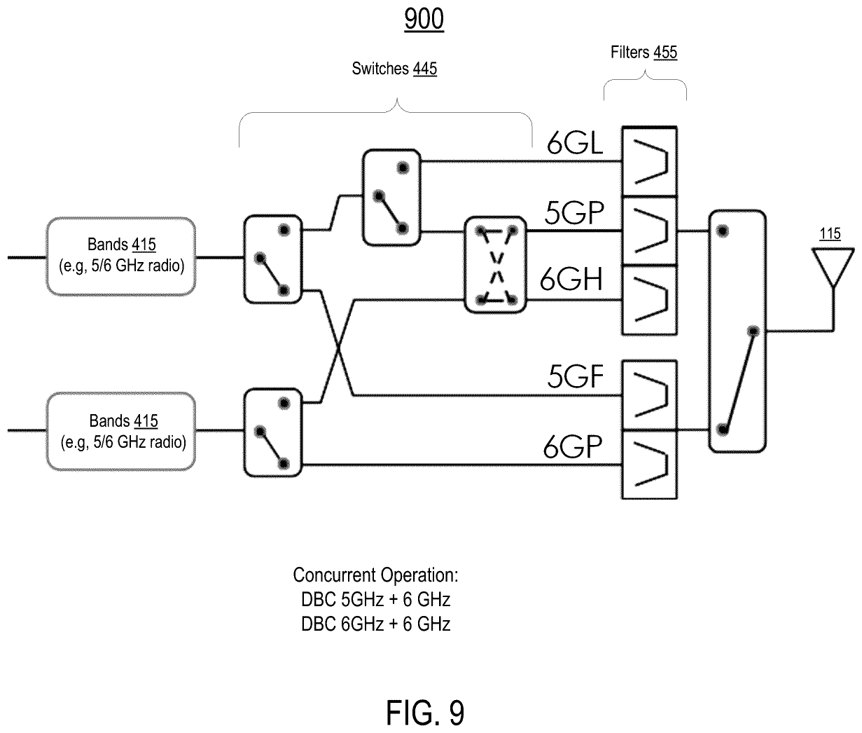

FIG. 9 illustrates an example system 900 switching between five filters 455 to achieve a dual band concurrent (DBC) operation of the 5 GHz and 6 GHz band communications. Example system 900 can include an example circuit or a device for selecting between two different diplexers 450. The top three filters 455 can correspond to a first diplexer 450 and provide a 6 GHz low end band 415 (e.g., 6GL), a 5 GHz partial band 415 and a 6 GHz high end band 415 (e.g., 6GH). The bottom two filters 455 can correspond to a second diplexer 450 and provide a 5 GHz full band 415 (e.g., 5GF) and 6 GHz partial band 415 (e.g., 6GP). Switches 445 (e.g., switch matrix) can allow signals from bands 415 (e.g., 5 GHz and/or 6 GHz data) to be routed via either the three top filters of the first diplexer 450 (e.g., 6GL, 5GP and 6GH) or two bottom filters 455 of the second diplexer 450 (e.g., 5GF or 6GP). In doing so, the system 900 can achieve or allow for DBC operation via any combination of two diplexers 450.

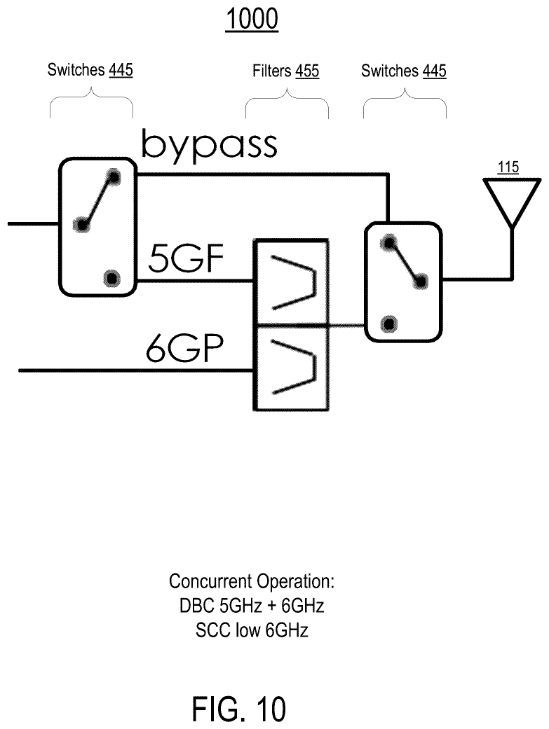

FIG. 10 illustrates an example system 1000 (e.g., a circuit) using a bypass and two different filters 455 (e.g., of a single diplexer 450) to achieve a dual band concurrent operation of the 5 GHz and 6 GHz band communications. Example system 1000 can include an example circuit or a device for selecting between a bypassed input signal and a diplexer 450. The top signal can be provided to a switch 445 and correspond to an input provided as a first of the two options to the switch 445. The second option can include two filters 455, which can correspond to a diplexer 450 providing a 5 GHz full band 415 (e.g., 5GF) and 6 GHz partial band 415 (e.g., 6GP). System 1000 can achieve or allow for concurrent operation via any combination of the bypass signal and the diplexer 450.

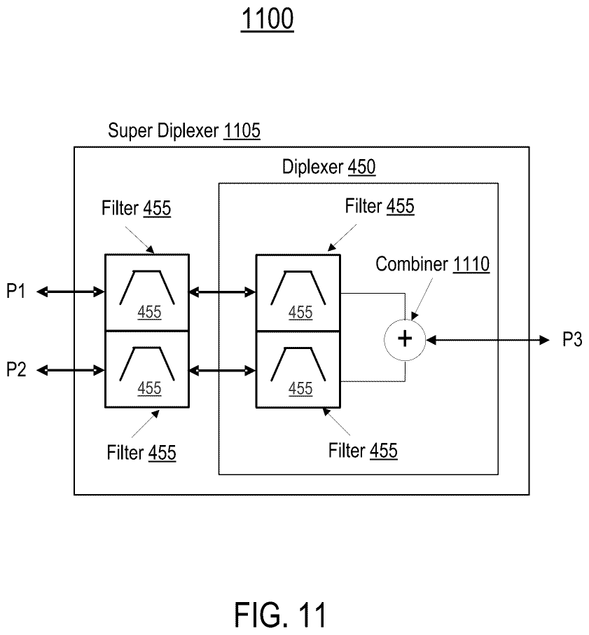

FIG. 11 illustrates an example system 1100 using a super diplexer 1105 with additional band pass filters 455 placed in series with filters 455 of the diplexer 450 to provide improved isolation (e.g., reduced or attenuated crosstalk or interference) between two frequency bands 415. Super diplexer 1105 can include a plurality of same or similar filters 455 arranged in a series. For example, a band pass filter (BPF) filter 455 of a particular frequency pass band 415 can be placed in a series with another filter 455 of the same frequency pass band 415. The same arrangement can be provided with the second filter 455 (e.g., the lower filter), so that another filter 455 with the same frequency parameters be placed in the series with it. In doing so, both the top filter 455 and the bottom filter 455 can provide improved filtering of the two bands 415.

For example, in example system 1100, a first signal P1 can be input into the top left filter 455, while a second signal P2 can be input into a bottom left filter 455. Each of the two filters 455 can be band pass filters allowing passage of frequencies via a first band 415 (e.g., the top left filter 455) and a second band 415 (e.g., the bottom left filter 455). Then, each of the output signals can be once again filtered by the same BPF filter 455 for each of the first and second bands 415. The resulting outputs from the second group of filters 455 can be provided to a combiner 1110. Combiner 1110 can include any electronic device that merges two signals with specific frequency ranges into a single output while maintaining the integrity of their respective frequency components. In doing so, the super diplexer 1105 can utilize the additional filters 455 and the combiner 1110 to improve the isolation between the two (e.g., or more) frequency bands 415.

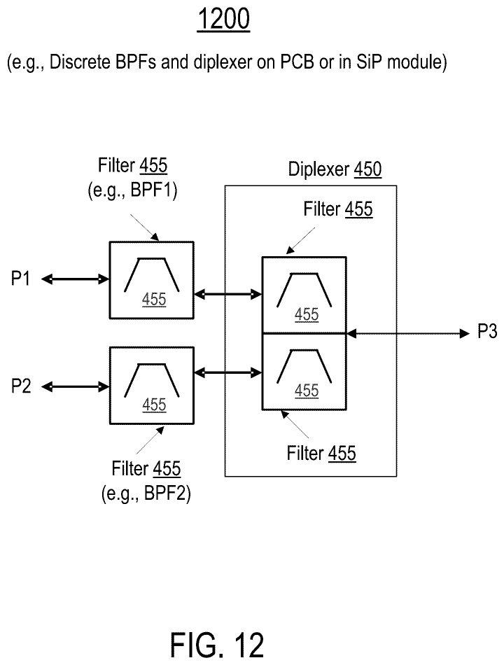

FIG. 12 illustrates an example system 1200 using a super diplexer with discrete band pass filters and diplexer deployed on a PCB or a SiP module. Example system 1200 can include a super diplexer 1105 with discrete BPFs and one or more diplexers 450 provided on a printed circuit board (PCB) or a system in package (SiP) module. SiP module can include any integrated circuit package that incorporates multiple components, such as microchips, memory, sensors, and passive components, into a single module, system or device to provide a compact solution to be used in a variety of systems or applications.

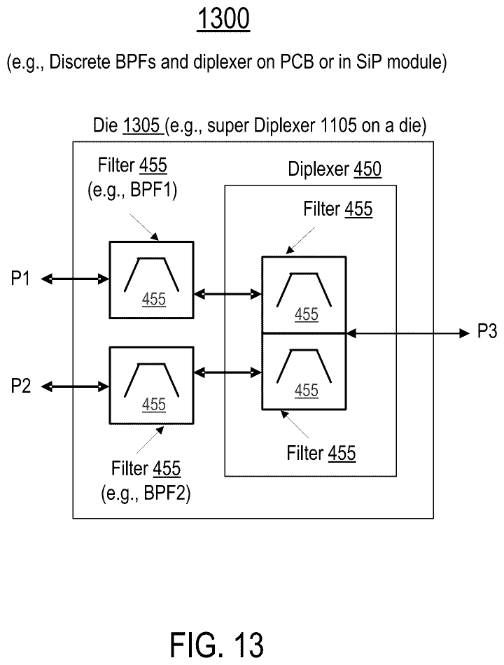

FIG. 13 illustrates an example system 1300 using a super diplexer with discrete band pass filters and diplexer deployed on a semiconductor die. For example, a die 1305, such as a semiconductor die with semiconductor circuitry. Die 1305 can include super diplexer 1105 along with sensors or other devices that can be configured to facilitate operation of super diplexer 1105. For example, die 1305 can include a super diplexer 1105 with a series of filters 455 in series with filters 455 of a diplexer 450. Die 1305 can be configured as a part of a semiconductor circuit, device or a system.

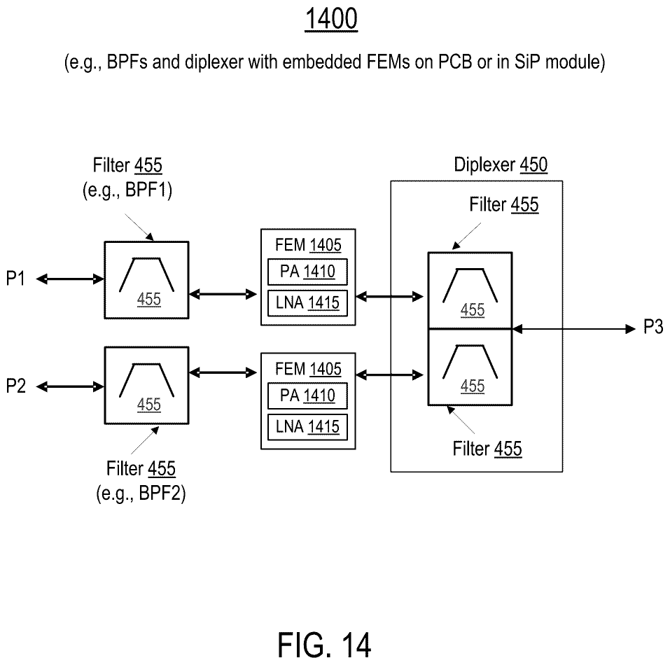

FIG. 14 illustrates an example system 1400 using a super diplexer with band pass filters and embedded front end modules (FEMs) on PCB or a SiP module. Inserted in between the filters 455 in series with the filters 455 of the diplexer 450 can be front end modules (FEMs) 1405. Each FEM 1405 can include one or more power amplifiers (PA) 1410 and low noise amplifiers (LNA) 1415. FEM 1405 can utilize a PA 1410 and a LNA 1415 as integrated components between two BPS filters 455. FEM 1405 can amplify outbound signals from the first filter 455 and enhance weak inbound signals while helping maintain signal integrity and preventing interference within the frequency bands 415. Each filter 455 of the diplexer 450 can receive an input from the FEM 1405, which can be fed by the preceding filter 455. In doing so, the input signals can be amplified, in addition to the attenuation of the unwanted frequencies.

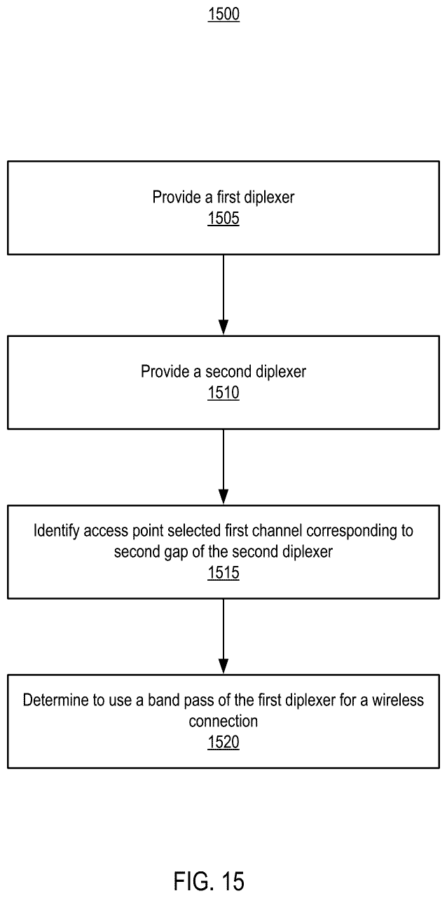

FIG. 15 illustrates an example flow diagram of a method 1500 for providing a real-time dual-band concurrent communication between wireless devices via a switch-configurable, front-end diplexer architecture. Method 1500 can be implemented by a system 400, which can be combined with any example systems 500-1400, and can include any embodiments described in connection with FIGS. 1-14. The method can include acts 1505-1020. At 1505, the method provides a first diplexer. At 1510 the method provides a second diplexer. At 1515, the method identifies access point selected first channel corresponding to a second gap of the second diplexer. At 1520, the method determines to use a band pass of the first diplexer for a wireless connection.

At 1505, the method provides a first diplexer. The method can include providing a first diplexer having a first pass band for a first wireless connection between an access point and a first device. The first diplexer can include a second pass band for a second wireless connection between the first device and a second device. The first pass band and the second pass band can be separated by a first gap of a first frequency width. The method can include arranging, coupling, connecting, configuring, or initiating the first diplexer as a part of a system or a device.

The first diplexer can include any diplexer having one or more gaps separating two or more frequency bands (e.g., pass bands) from each other. For example, the first diplexer can include a frequency gap separating two adjacent frequency pass bands. The first diplexer can include two frequency gaps separating three frequency bands, or any other number of gaps separating any number of frequency bands. Each pass band of the diplexer can be provided by one or more band pass filters, or any combination of low pass, high pass and/or band pass filters. The one or more filters can be configured to eliminate, attenuate or block frequencies above an upper cutoff frequency and below a lower cutoff frequency for each frequency band of the plurality of bands in the diplexer.

A first pass band of the first diplexer can correspond to or provide any number of channels for interlink connections between an access point and the computing device. For example, a first pass band of the first diplexer can include the first pass band of between 5170 MHz and 5835 MHz (e.g., in the 5 GHz full spectrum configuration). A second pass band of the first diplexer can correspond to or provide any number of channels for intralink connections between the computing device and an auxiliary device, such as a HWD or AR glasses. For example, a second pass band of the first diplexer can include the second pass band of between 6105 MHz and 7125 MHz (e.g., in the 6 GHz partial spectrum configuration).

A gap between two adjacent or neighboring frequency bands of the first diplexer can include a frequency width within which signal propagation is attenuated, blocked or stopped. Gap can include a frequency range of blocked signals between two adjacent bands. Gap can be at least 50 MHz wide, 100 MHz wide, 150 MHz wide, 200 MHz wide, 250 MHz wide, 300 MHz wide, 350 MHz wide, 400 MHz wide, 500 MHz wide or more. Gap can be, for example between 200 and 250 MHz wide. For example, gap between the first pass band and the second pass band can be between 5835 MHz and 6105 MHz.

The method can include providing the first diplexer as a part of a system, such as a component on a PCB, or a SiP. The first diplexer can be provided as a circuit component of an integrated circuit or a system on a semiconductor die. The method can include the first diplexer coupled with one or more switches (e.g., a switch matrix) for selecting or unselecting the diplexer for use with respect to one or more wireless connections. The method can include providing a first diplexer having a first pass band or the second pass band corresponding to 5 GHz band, such as a band between 5000 MHz and 6000 MHz, a 6 GHz band, such as between 6000 GHz and 7000 GHz, or a 2.4 GHz frequency band (e.g., 2400 MHz to 2483 MHz)

At 1510 the method provides a second diplexer. The method can include providing a second diplexer having a third pass band for the first wireless connection and a fourth pass band for the second wireless connection. The third pass band and the fourth pass band can be separated by a second gap of a second frequency width. The first pass band and the third pass band can partially overlap with each other. The second pass band and the fourth pass band can partially overlap with each other. The method can include arranging, coupling, connecting, configuring, or initiating the second diplexer as a part of a system or a device.

The second diplexer can include any diplexer having one or more gaps separating two or more frequency bands (e.g., pass bands) from each other. For example, the second diplexer can include a frequency gap separating two adjacent frequency pass bands, two frequency gaps separating three frequency bands, or any other number of gaps separating any number of frequency bands. Each pass band of the diplexer can be provided by one or more band pass filters, or any combination of low pass, high pass and/or band pass filters. The one or more filters of the second diplexer can be configured to eliminate, attenuate or block frequencies above an upper cutoff frequency and below a lower cutoff frequency for each frequency band of the plurality of bands in the diplexer.

A second pass band of the second diplexer can correspond to or provide any number of channels for interlink connections between the access point device and the computing device. For example, a third pass band of the second diplexer (e.g., the first of the two pass bands in the second diplexer) can include the third pass band of between 5170 MHz and 5730 MHz (e.g., in the 5 GHz partial spectrum configuration). A fourth pass band of the second diplexer (e.g., the second of the two pass bands of the second diplexer) can correspond to or provide any number of channels for intralink connections between the computing device and an auxiliary device, such as a HWD or AR glasses. For example, a fourth pass band of the second diplexer can include the second pass band of between 5945 MHz and 7125 MHz (e.g., in the 6 GHz full spectrum configuration).

A gap between two adjacent or neighboring frequency bands of the second diplexer can include a frequency width within which signal propagation is attenuated, blocked or stopped. Gap can include a frequency range of blocked signals between two adjacent bands. Gap width can be the same or a different width as the gap in the first diplexer. For example, gap of the second diplexer can be between 200 and 250 MHz wide. For example, gap between the third pass band and the fourth pass band can be between 5730 MHz and 5945 MHz.

As with the first diplexer, the method can include providing the second diplexer as a part of a system, such as a component on a PCB, a SiP or a circuit on a semiconductor die. As with the first diplexer, the method can include the second diplexer coupled with one or more switches (e.g., a switch matrix) for selecting or unselecting the diplexer for use with respect to one or more wireless connections. The method can include providing a second diplexer having a third pass band or the fourth pass band corresponding to 5 GHz band, such as a band between 5000 MHz and 6000 MHz, a 6 GHz band, such as between 6000 GHz and 7000 GHz, or a 2.4 GHz frequency band (e.g., 2400 MHz to 2483 MHz)

The method can include configuring/having the first frequency width of the first gap and the second frequency width of the second gap to be partially overlapping with each other. The first gap and the second gap can have the same or different sizes (e.g., widths), such as 200 MHz, 250 MHz, 300 MHz or more. The first frequency width of the first gap can partially overlap with the fourth pass band. The second frequency width of the second gap can partially overlap with the first pass band.

For example, the first diplexer and the second diplexer can correspond to at least a portion of a frequency range of between 5150 MHz and 7125 MHz. For example, the first frequency width and the second frequency can correspond to at least 200 MHz. For example, isolation between the first pass band and the second pass band and isolation between the third pass band and the fourth pass band can be at least 50 dB. For example, the isolation of at least 50 dB can include a 50 dB difference between the signals being transmitted via the bands (e.g., provided by the filters) and any signals outside of the bands (e.g., via gaps).

At 1515, the method includes identifying access point selected first channel corresponding to a second gap of the second diplexer. The method can include at least one processor identifying that the access point has selected, for the first wireless connection between the access point and the first device (e.g., interlink connection), a first channel corresponding to the second frequency width of the second gap. For example, the method can include one or more processors determining, detecting or identifying that an access point has selected a channel for an interlink connection with the computing device where the channel overlaps or conflicts with a gap in one of the diplexers (e.g., second diplexer).

The at least one processor can include one or more processors coupled with memory storing instructions for causing the processor to perform the identification, determination or detection of the channel selected by the access point. The method can include the at least one processor detecting that the first channel falls within the second frequency width of the second gap of the second diplexer. The at least one processor can compare the frequency range of the selected channel against the frequency range of the gap to determine the conflict between the two. In response to such a determination, the at least one processor can eliminate the diplexer having such a conflicting gap from the group of diplexers to use (e.g., select a diplexer that does not have the conflicting gap).

At 1520, the method includes determining to use a band pass of the first diplexer for a wireless connection. The method can include the at least one processor determining to use the second pass band for the second wireless connection between the first device and the second device. The at least one processor can make this determination responsive to the detection or identification at 1515. The at least one processor can determine to use the first pass band of the first diplexer for the first connection and the second pass band of the first diplexer for the second connection responsive to the identification that the first channel falls within the second frequency width of the second gap.

The method can include providing, connecting, coupling or forming a switch that is connected, coupled or in electrical communication with the first diplexer and the second diplexer. The switch can be configured, arranged or connected to select, responsive to the determination, between the first diplexer and the second diplexer. The method can include providing an antenna coupled to the switch. The antenna can be configured to transmit or receive wireless communications using the first or the second diplexer, selected by the switch. The method can include providing a switch configured to select the first diplexer from the first diplexer and the second diplexer in response to detecting that the second pass band corresponds the first diplexer.

The method can include the at least one processor determining to provide a first communication via the first connection between the access point and the first device through the first channel of a first pass band. The at least one processor can determine to provide a second communication via the second connection between the first device and the second device through a second channel of the second pass band. For example, the at least one processor can communicate interlink communication via the first channel of the first pass band and communicate intralink communication via the second channel of the second pass band. The method can include configuring a switch to couple an antenna to the first diplexer a communicate the first communication through the first pass band of the first diplexer. The method can include communicating the second communication through the second pass band of the first diplexer.

The at least one processor can identify that the access point has selected, for a third wireless connection between the access point and the first device, a third channel corresponding to the first frequency width of the first gap. The third channel can be for another communication with the computing device or with another auxiliary device via the computing device. The at least one processor can determine responsive to the detection for the third wireless connection, to use the fourth pass band for a fourth second wireless connection between the first device and a third device. The at least one processor can determine to provide a third communication via the third wireless connection between the access point and the first device through the third channel of a third pass band. The at least one processor can determine to provide a fourth communication via the fourth wireless connection between the first device and the second device through a second channel of the fourth pass band. The fourth communication can be an intralink communication with another auxiliary device. The at least one processor can configure, command or trigger a switch to couple an antenna to the second diplexer, communicate the first communication through the third pass band of the second diplexer and communicate the second communication through the fourth pass band of the second diplexer.

Although this disclosure provides various examples referring to an interlink and/or an intralink, these are merely by way of illustration and not intended to be limiting in any way. In place of these, any two or more links (of the same protocol or different protocols) can apply. In addition, this disclosure provides various examples referring to an access point and/or a HWD, merely by way of illustration and not intended to be limiting in any way. In place of these, any two or more devices (of the same type or different types) can apply.

Having now described some illustrative implementations, it is apparent that the foregoing is illustrative and not limiting, having been presented by way of example. In particular, although many of the examples presented herein involve specific combinations of method acts or system elements, those acts, and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled”, and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

We claim:

1. A system comprising:
a first diplexer having a first pass band for a first wireless connection between an access point and a first device, and a second pass band for a second wireless connection between the first device and a second device, the first pass band and the second pass band separated by a first gap of a first frequency width;
a second diplexer having a third pass band for the first wireless connection, and a fourth pass band for the second wireless connection, the third pass band and the fourth pass band separated by a second gap of a second frequency width, wherein the first pass band and the third pass band partially overlap with each other, and the second pass band and the fourth pass band partially overlap with each other; and
at least one processor to:
identify that the access point has selected, for the first wireless connection between the access point and the first device, a first channel corresponding to the second frequency width of the second gap; and
determine, responsive to the identification, to use the second pass band for the second wireless connection between the first device and the second device.

2. The system of claim 1, comprising:
a switch coupled to the first diplexer and the second diplexer to select, responsive to the determination, between the first diplexer and the second diplexer; and
an antenna coupled to the switch.

3. The system of claim 1, wherein the at least one processor is configured to:
detect that the first channel falls within the second frequency width of the second gap; and
determine to use the first pass band of the first diplexer for the first connection and the second pass band of the first diplexer for the second connection responsive to the detection.

4. The system of claim 3, comprising:
a switch configured to select the first diplexer from the first diplexer and the second diplexer in response to detecting that the second pass band corresponds the first diplexer.

5. The system of claim 1, wherein the first frequency width of the first gap and the second frequency width of the second gap partially overlap with each other and have different sizes.

6. The system of claim 1, wherein the first frequency width of the first gap partially overlaps with the fourth pass band and the second frequency width of the second gap partially overlaps with the first pass band.

7. The system of claim 1, wherein:
the first diplexer and the second diplexer correspond to at least a portion of a frequency range of between 5150 MHz and 7125 MHz;
the first frequency width and the second frequency correspond to at least 200 MHz; and
isolation between the first pass band and the second pass band and between the third pass band and the fourth pass band is at least 50 dB.

8. The system of claim 1, wherein the at least one processor is configured to:
determine to provide a first communication via the first connection between the access point and the first device through the first channel of a first pass band;
determine to provide a second communication via the second connection between the first device and the second device through a second channel of the second pass band;
configure a switch to couple an antenna to the first diplexer; and
communicate the first communication through the first pass band of the first diplexer, and
communicate the second communication through the second pass band of the first diplexer.

9. The system of claim 1, wherein the at least one processor is configured to:
identify that the access point has selected, for a third wireless connection between the access point and the first device, a third channel corresponding to the first frequency width of the first gap; and
determine, responsive to the detection for the third wireless connection, to use the fourth pass band for a fourth wireless connection between the first device and a third device.

10. The system of claim 9, wherein the at least one processor is configured to:
determine to provide a third communication via the third wireless connection between the access point and the first device through the third channel of a third pass band;
determine to provide a fourth communication via the fourth wireless connection between the first device and the second device through a second channel of the fourth pass band;
configure a switch to couple an antenna to the second diplexer;
communicate the first communication through the third pass band of the second diplexer, and
communicate the second communication through the fourth pass band of the second diplexer.

11. A method comprising:
providing a first diplexer having a first pass band for a first wireless connection between an access point and a first device and a second pass band for a second wireless connection between the first device and a second device, the first pass band and the second pass band separated by a first gap of a first frequency width;
providing a second diplexer having a third pass band for the first wireless connection and a fourth pass band for the second wireless connection, the third pass band and the fourth pass band separated by a second gap of a second frequency width, wherein the first pass band and the third pass band partially overlap with each other, and the second pass band and the fourth pass band partially overlap with each other;
identifying, by at least one processor, that the access point has selected, for the first wireless connection between the access point and the first device, a first channel corresponding to the second frequency width of the second gap; and
determining, by the at least one processor responsive to the identification, to use the second pass band for the second wireless connection between the first device and the second device.

12. The method of claim 11, comprising:
providing a switch coupled to the first diplexer and the second diplexer to select, responsive to the determination, between the first diplexer and the second diplexer; and
providing an antenna coupled to the switch.

13. The method of claim 11, comprising:
detecting, by the at least one processor, that the first channel falls within the second frequency width of the second gap; and
determining, by the at least one processor, to use the first pass band of the first diplexer for the first connection and the second pass band of the first diplexer for the second connection responsive to the detection.

14. The method of claim 13, comprising:
providing a switch configured to select the first diplexer from the first diplexer and the second diplexer in response to detecting that the second pass band corresponds the first diplexer.

15. The method of claim 11, wherein the first frequency width of the first gap and the second frequency width of the second gap partially overlap with each other and have different sizes.

16. The method of claim 11, wherein the first frequency width of the first gap partially overlaps with the fourth pass band and the second frequency width of the second gap partially overlaps with the first pass band.

17. The method of claim 1, wherein:
the first diplexer and the second diplexer correspond to at least a portion of a frequency range of between 5150 MHz and 7125 MHz;
the first frequency width and the second frequency correspond to at least 200 MHz; and
isolation between the first pass band and the second pass band and between the third pass band and the fourth pass band is at least 50 dB.

18. The method of claim 11, comprising:
determining, by the at least one processor, to provide a first communication via the first connection between the access point and the first device through the first channel of a first pass band;
determining, by the at least one processor, to provide a second communication via the second connection between the first device and the second device through a second channel of the second pass band;
configuring a switch to couple an antenna to the first diplexer; and
communicating the first communication through the first pass band of the first diplexer, and
communicating the second communication through the second pass band of the first diplexer.

19. The method of claim 11, comprising:
identifying, by the at least one processor, that the access point has selected, for a third wireless connection between the access point and the first device, a third channel corresponding to the first frequency width of the first gap; and
determining, by the at least one processor, responsive to the detection for the third wireless connection, to use the fourth pass band for a fourth second wireless connection between the first device and a third device;
determining, by the at least one processor, to provide a third communication via the third wireless connection between the access point and the first device through the third channel of a third pass band;
determining, by the at least one processor, to provide a fourth communication via the fourth wireless connection between the first device and the second device through a second channel of the fourth pass band;
configuring a switch to couple an antenna to the second diplexer;
communicating the first communication through the third pass band of the second diplexer, and
communicating the second communication through the fourth pass band of the second diplexer.

20. A device comprising:
a first diplexer having a first pass band for a first wireless connection between an access point and a first device and a second pass band for a second wireless connection between the first device and a second device, the first pass band and the second pass band separated by a first gap of a first frequency width;
a second diplexer having a third pass band for the first wireless connection and a fourth pass band for the second wireless connection, the third pass band and the fourth pass band separated by a second gap of a second frequency width, wherein the first pass band and the third pass band partially overlap with each other, and the second pass band and the fourth pass band partially overlap with each other; and
at least one processor configured to:
identify that the access point has selected, for the first wireless connection between the access point and the first device, a first channel corresponding to the second frequency width of the second gap; and
determine, responsive to the identification, to use the second pass band for the second wireless connection between the first device and the second device.
